(19) United States
(12) Patent Application Publication
(10) Pub. No.: US 2005/0009387 A1
(43) Pub. Date: Jan. 13, 2005

(54) Distal power supply device for network facility

(76) Inventor: Eldon Chang, Hsin Chuang City (TW)

Correspondence Address: Eldon Chang, P.O. Box 4-67, Hsin Chuang, Taipei, 242, TW

(21) Appl. No.: 10/455,190

(22) Filed: Jun. 3, 2003

(51) Int. Cl. H01R 4/66

(52) U.S. Cl. 439/92; 361/679

(57) ABSTRACT

A network facility for communicating end users with network systems includes a network control device for coupling to the end users and having an interface and a network processor device, a power supply device for coupling to the network systems, a cable device having one coupler coupled to the power supply device, and another coupler coupled to the interface of the network control device. An adapter for coupling to electric power suppliers includes one or more terminals coupled to terminals of the cable device, to supply electric power to energize the network control device via the cable device, without coupling the network control device to electric power suppliers.

### BACKGROUND OF THE INVENTION

1. Field of the Invention

The present invention relates to a network facility, and more particularly to a network facility having a distal power supply device for allowing various users or network control devices to be coupled to various network systems without additional power supply devices.

2. Description of the Prior Art

Various kinds of typical network facilities have been developed and provided for communicating end users with various network systems, and comprise a network control device for coupling to and for communicating with the network systems.

Normally, a number of network control devices are required to be provided and installed in different areas or locations and each provided for communicating the end users located in these areas or locations with the network systems.

For example, in three different areas or locations A, B, C, three network control devices are required to be provided and installed in these three different areas or locations A, B, C respectively, for coupling to and for communicating the end users in these areas or locations with the network systems respectively.

However, the network control devices are required to be coupled to or plugged to different power suppliers, in order to energize and to operate the network control devices. Some times, or in some areas, it may be difficult to find an electric power supply and to couple the network control device to the electric power supply, such that the network control devices may not be easily installed in some areas.

The present invention has arisen to mitigate and/or obviate the afore-described disadvantages of the conventional network facilities.

### SUMMARY OF THE INVENTION

The primary objective of the present invention is to provide a network facility including a distal power supply device for allowing various users or network control devices to be coupled to various network systems without additional power supply devices.

In accordance with one aspect of the invention, there is provided a network facility for communicating end users with network systems, the network facility comprising a network control device for coupling to the end users, the network control device including an interface, and a network processor device for signal processing purposes, a power supply device for coupling to the network systems, a first cable device including a first coupler coupled to the power supply device, and a second coupler coupled to the interface of the network control device. The first coupler of the first cable device includes at least one first terminal for signal transmitting purposes, and at least one second terminal for power transmitting purposes. An adapter is provided for coupling to electric power suppliers, the adapter includes at least one first terminal coupled to the second terminal of the first coupler of the first cable device, to supply electric power to energize the network control device via the first cable device, without coupling the network control device to electric power suppliers.

The network control device includes a signal converting device coupled between the interface and the network processor device, to communicate signals between the interface and the network processor device.

The second coupler of the first cable device includes at least one first terminal for signal transmitting purposes, and at least one second terminal for power transmitting purposes, and the signal converting device includes at least one first terminal for signal transmitting purposes and for coupling to the first terminal of the second coupler of the first cable device.

The second coupler of the first cable device includes at least one third terminal for grounding purposes, and the signal converting device includes at least one second terminal for grounding purposes and for coupling to the third terminal of the second coupler of the first cable device.

The network control device includes a power transforming device coupled between the interface and the network processor device, to covert and to supply electric power to the network processor device.

The second coupler of the first cable device includes at least one first terminal for grounding purposes, and at least one second terminal for power transmitting purposes, and the power transforming device includes at least one first terminal for power transmitting purposes and for coupling to the first terminal of the second coupler of the first cable device.

The power transforming device includes at least one second terminal for grounding purposes and for coupling to the first terminal of the second coupler of the first cable device.

The network control device further includes a first diode coupled between the interface and the power transforming device, a second adapter, and a second diode coupled between the first diode and the second adapter, to selectively couple the network control device to electric power sources via the first and the second diodes and the second adapter.

The network control device includes a second interface coupled to the network processor device for coupling to the end users.

A second cable device may further be provided for coupling the power supply device to the network systems, the second cable device includes a coupler having at least one first terminal for signal transmitting purposes and for coupling to the first terminal of the first coupler of the first cable device.

The coupler of the second cable device includes at least one second terminal for grounding purposes, and the first coupler of the first cable device includes at least one third terminal for grounding purposes and for coupling to the second terminal of the coupler of the second cable device.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a schematic view of a network facility in accordance with the present invention;

FIG. 2 is a block diagram of a network control device of the network facility;

FIG. 3 is a block diagram of a distal power supply device of the network facility;

FIG. 4 is a block diagram illustrating the operation of the network control device of the network facility; and

FIG. 5 is a block diagram similar to FIG. 2, illustrating the other arrangement of the network facility.

### DETAILED DESCRIPTION OF THE PREFERRED EMBODIMENT

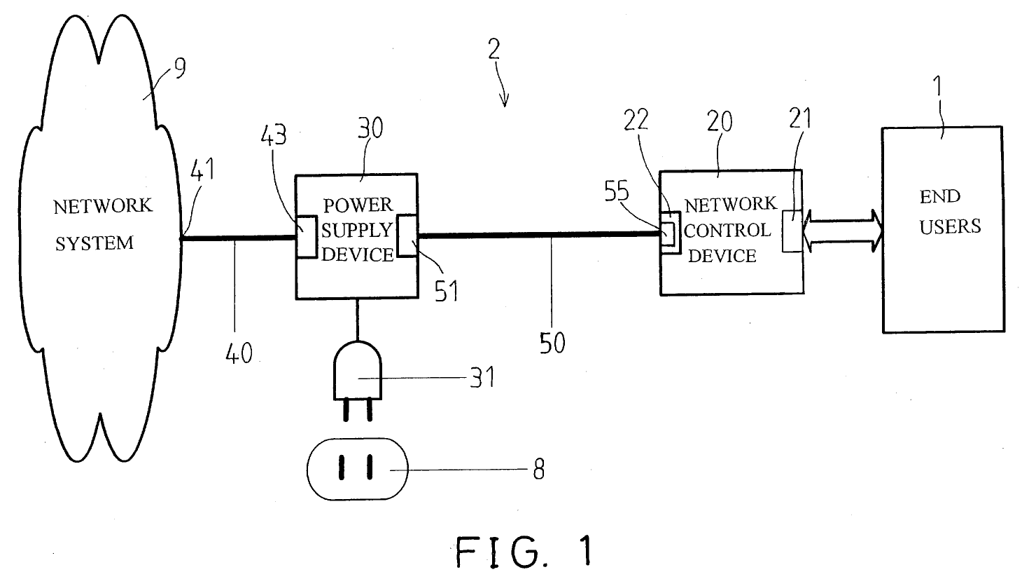

Referring to the drawings, and initially to FIG. 1, a network facility in accordance with the present invention is generally indicated with a reference numeral “2” and comprises a network control device 20 and a distal power supply device 30 coupled together, for communicating end users 1 with various network systems 9.

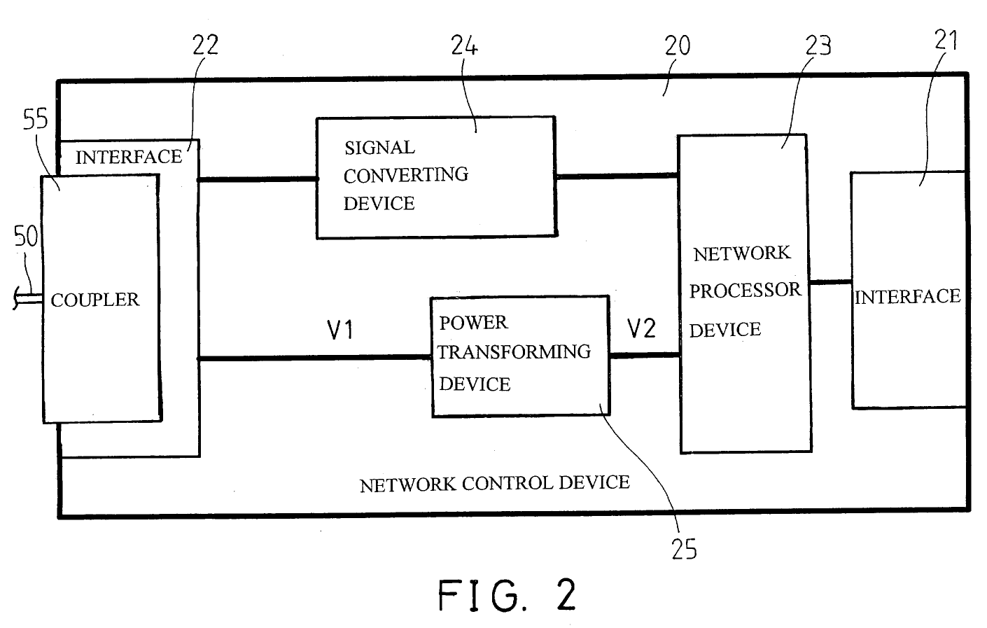

As shown in FIG. 2, the network control device 20 includes a coupler or interface 21 for coupling to the end users 1 either via cable connections or via wireless communicating systems, another coupler or interface 22 for coupling to the power supply device 30, and a network chip or integrated circuit or processor device 23 coupled to the interface 21, for receiving and processing signals between the end users 1 and the network systems 9.

The network control device 20 further includes a signal converting device 24 coupled between the interface 22 and the network processor device 23, for converting voltage signals and/or package or digital signals between the power supply device 30 and the network processor device 23.

The network control device 20 further includes a power transforming device 25 coupled between the interface 22 and the network processor device 23, for converting or transforming electric power or voltage from V1 (such as +48V AC) to V2 (such as 5V DC), and for supplying the power supply V2 to energize the network processor device 23.

The power supply device 30 is provided for being coupled between the network control device 20 and the network systems 9, with cable devices 40, 50, as shown in FIG. 1. For example, the cable devices 40, 50 may be the typical remote job RJ-45 cable devices 40, 50 each of which includes two or more wires (not shown) provided therein.

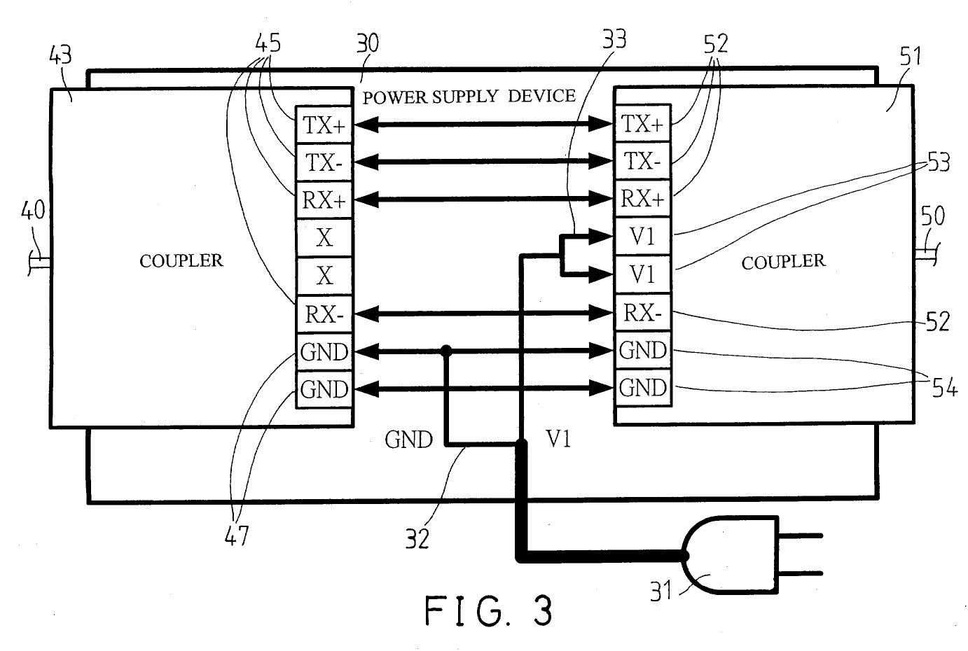

The cable device 40 includes one end 41 coupled to the network system 9, and a coupler 43 provided or attached to the other end thereof, for coupling to the power supply device 30. As shown in FIG. 3, the coupler 43 of the cable device 40 includes one or more terminals 45 for signal transmitting purposes, and one or more terminals 47 for grounding purposes.

As also shown in FIG. 3, the other cable device 50 includes a coupler 51 provided or attached to one end for coupling to the power supply device 30, and another coupler 55 provided or attached to the other end thereof, for coupling to the interface 22 of the network control device 20 (FIGS. 1, 2).

As shown in FIG. 3, the coupler 51 of the cable device 50 includes one or more terminals 52 for coupling to the terminals 45 of the cable device 40 and for signal transmitting purposes, and one or more terminals 54 for coupling to the terminals 47 of the cable device 40 and for grounding purposes, and further includes one or more terminals 53 for power transmitting purposes.

The power supply device 30 includes a coupler or an adapter 31 for coupling to various electric power suppliers 8 (FIG. 1), such as the electric power supply 8 of house families, vehicles, or the like. As shown in FIG. 3, the adapter 31 includes one or more terminals 32 for coupling to the terminals 47, 54 of the cable devices 40, 50 and for grounding purposes, and one or more terminals 33 for coupling to the terminals 53 of the cable device 50 and for power transmitting purposes.

As shown in FIG. 3, when the terminals 53 of the cable device 50 are coupled to or energized by the electric power suppliers 8, the electric power or energy from the electric power suppliers 8 may thus be supplied to energize the cable device 50, and thus to allow signals to be transmitted between the cable devices 40, 50.

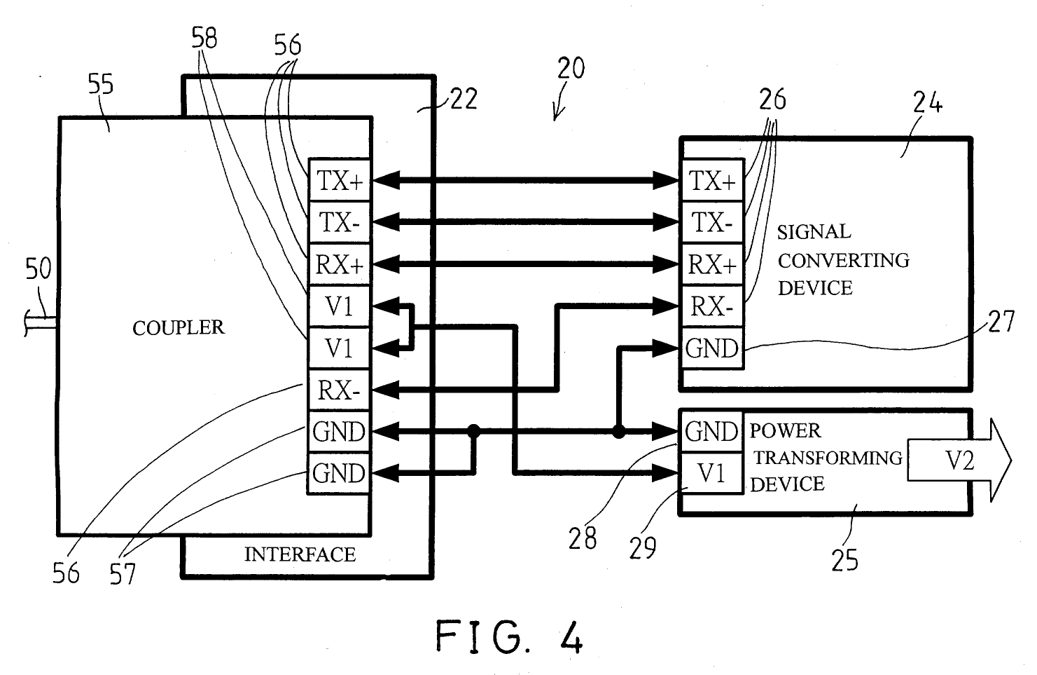

As shown in FIG. 4, the other coupler 55 of the cable device 50 also includes one or more terminals 56 for coupling to the corresponding terminals 26 of the signal converting device 24, and includes one or more terminals 57 for coupling to the corresponding terminals 27, 28 of the signal converting device 24 and the power transforming device 25 for grounding purposes, and includes one or more terminals 58 for coupling to the corresponding terminals 29 of the power transforming device 25 for power transmitting purposes.

The power transforming device 25 may then transform the electric power or voltage from V1 (such as +48V AC) to V2 (such as 5V DC), and for supplying the power supply V2 to energize the network processor device 23. It is to be noted that the network control device 20 may thus be energized by the electric power suppliers 8 via the adapter 31 and the cable 50, and is not required to be directly coupled to the electric power suppliers 8.

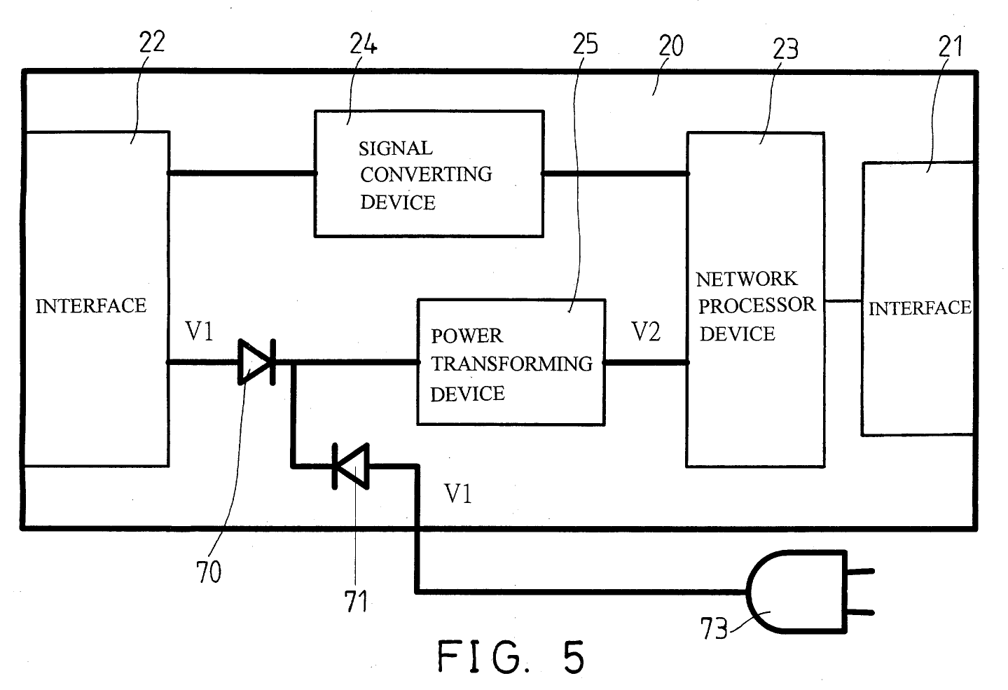

As shown in FIG. 5, the network control device 20 may further includes a diode 70 selectively or optionally provided and coupled between the interface 22 and the power transforming device 25, and coupled to another adapter 73 via the other diode 71. The adapter 73 may also be coupled to various electric power suppliers 8, to directly selectively or optionally energize the network control device 20.

In operation, the network control device 20 may be coupled to the power supply device 30, and energized by or via the adapter 31 and the power supply device 30 and the cable device 50, such that the network control device 20 is not required to be directly coupled to the electric power suppliers 8. The other network control devices 20 may also be coupled to the power supply device 30, and energized by the power supply device 30 without coupling to various electric power suppliers 8.

Accordingly, the network facility in accordance with the present invention includes a distal power supply device for allowing various users or network control devices to be coupled to various network systems without additional power supply devices.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

1. A network facility for communicating end users with network systems, said network facility comprising:
a network control device for coupling to the end users, said network control device including an interface, and a network processor device for signal processing purposes,
a power supply device for coupling to the network systems,
a first cable device including a first coupler coupled to said power supply device, and a second coupler coupled to said interface of said network control device,
said first coupler of said first cable device including at least one first terminal for signal transmitting purposes, and at least one second terminal for power transmitting purposes, and
an adapter for coupling to electric power suppliers, said adapter including at least one first terminal coupled to said at least one second terminal of said first coupler of said first cable device, to supply electric power to energize said network control device via said first cable device, without coupling said network control device to electric power suppliers.

2. The network facility as claimed in claim 1, wherein said network control device includes a signal converting device coupled between said interface and said network processor device, to communicate signals between said interface and said network processor device.

3. The network facility as claimed in claim 2, wherein said second coupler of said first cable device includes at least one first terminal for signal transmitting purposes, and at least one second terminal for power transmitting purposes, and said signal converting device includes at least one first terminal for signal transmitting purposes and for coupling to said at least one first terminal of said second coupler of said first cable device.

4. The network facility as claimed in claim 3, wherein said second coupler of said first cable device includes at least one third terminal for grounding purposes, and said signal converting device includes at least one second terminal for grounding purposes and for coupling to said at least one third terminal of said second coupler of said first cable device.

5. The network facility as claimed in claim 1, wherein said network control device includes a power transforming device coupled between said interface and said network processor device, to covert and to supply electric power to said network processor device.

6. The network facility as claimed in claim 5, wherein said second coupler of said first cable device includes at least one first terminal for grounding purposes, and at least one second terminal for power transmitting purposes, and said power transforming device includes at least one first terminal for power transmitting purposes and for coupling to said at least one first terminal of said second coupler of said first cable device.

7. The network facility as claimed in claim 6, wherein said power transforming device includes at least one second terminal for grounding purposes and for coupling to said at least one first terminal of said second coupler of said first cable device.

8. The network facility as claimed in claim 5, wherein said network control device further includes a first diode coupled between said interface and said power transforming device, a second adapter, and a second diode coupled between said first diode and said second adapter, to selectively couple said network control device to electric power sources via said first and said second diodes and said second adapter.

9. The network facility as claimed in claim 1, wherein said network control device includes a second interface coupled to said network processor device for coupling to the end users.

10. The network facility as claimed in claim 1 further comprising a second cable device for coupling said power supply device to the network systems, said second cable device including a coupler having at least one first terminal for signal transmitting purposes and for coupling to said at least one first terminal of said first coupler of said first cable device.

11. The network facility as claimed in claim 10, wherein said coupler of said second cable device includes at least one second terminal for grounding purposes, and said first coupler of said first cable device includes at least one third terminal for grounding purposes and for coupling to said at least one second terminal of said coupler of said second cable device.
